(19) United States
(12) Patent Application Publication
(10) Pub. No.: US 2003/0205072 A1
(43) Pub. Date: Nov. 6, 2003

(54) Soil improving and fertilising composition

(76) Inventor: Pieter Gideo Van Der Merwe, Pretoria (ZA)

Correspondence Address: Law Offices of Albert Wai-Kit Chan, LLC, World Plaza, Suite 604, 141-07 20th Avenue, Whitestone, NY, 11357, US

(21) Appl. No.: 10/434,902

(22) Filed: May 9, 2003

Related U.S. Application Data
(63) Continuation of application No. PCT/ZA01/00145, filed on Sep. 14, 2001.

(30) Foreign Application Priority Data
Nov. 9, 2000 (ZA) 2000/6460

(51) Int. Cl. C05C 1/00

(52) U.S. Cl. 71/27

(57) ABSTRACT

The invention provides a process for preparing a soil improving and fertilising composition from fertiliser and crosslinked copolymer, the process including imparting an electrical charge to at least one of said copolymer and the fertiliser and bringing said copolymer and fertiliser into intimate contact with each other. The fertiliser and crosslinked copolymer are believed to be mechanically fused to form the composition. The invention extends to a composition and to an agricultural or horticultural method using the composition.

### FIELD OF THE INVENTION

This invention relates to a soil improving and fertilising composition and to a process for preparation of said composition.

### BACKGROUND OF THE INVENTION

The applicant is aware that agricultural and horticultural soils are prone to drying out when there is low rainfall and leaching when there is high rainfall or irrigation.

One proposed solution was to distribute a water retaining polymeric substance in and on the soil thereby to improve water retention of the soil and to reduce soil leaching due to excessive watering or rain. Thus a plant's roots would directly access the water stored in the polymeric substance thereby ensuring adequate watering over extended periods.

However, a plant does not only require water for healthy growth but also nutrients and sunlight.

European Patent Application 0181983 to Beck L S A, discloses a sodium polyacrylamide polymer granule in which certain fertilising compounds are chemically fused to the polyacrylamide during the polymerisation and/or cross-linking process. The applicants for the present invention believe that the use of sodium based polymers in agriculture is unwise as this can lead to sailination of the soil. The chemical fusing of the fertilising compounds is likely to, in use, lead to retention of certain nutrients in the polymer.

The inventors therefore believe that a need exists for a soil improving and fertilising composition which improves water retention of the soil and reduces soil leaching due to excessive watering or rain, while also providing a reservoir of nutrients which are released into the soil for plant nutrition. Such a composition should be relatively easy to manufacture and thus a need also exists for a process for manufacturing the soil improving and fertilising composition.

### SUMMARY OF THE INVENTION

Thus, according to a first aspect of the invention there is provided a process for preparing a soil improving and fertilising composition from fertiliser and crosslinked copolymer, the process including imparting an electrical charge to at least one of said copolymer and the fertiliser and bringing said copolymer and fertiliser into intimate contact with each other.

The copolymer may be in the form of granules.

The electrical charge may be imparted by high shear mixing of the fertiliser and said copolymer. One indication that the process is substantially complete is that the composition bulk density increases visibly.

The high shear mixing may be carried out in a high speed mixing vessel.

The electrical charge may be imparted by negative charging with a corona discharge device, such as a corona-electroniser. The imparting of the negative charge may be assisted by mixing in a ribbon blender associated with the corona discharge device.

The high shear mixing may be carried out at a temperature of from ambient temperature to 50° C., or even 90° C., or even higher, depending on the copolymer used.

The crosslinked copolymer may be a crosslinked potassium copolymer, for example, a polyacrylate/polyacrylamide potassium crosslinked copolymer.

Typically the bulk density increases by at least 2%, usually by at least 5%.

It is believed that the bulk density increase is as a result of mechanical fusion between the copolymer and fertiliser during the process.

After the mixing is completed the composition bulk density remains substantially stable if kept dry.

The composition after mixing is friable and pours easily if kept dry.

The high shear mixing may be conducted under substantially dry conditions i.e. without the addition of additional moisture to the composition.

The high shear mixing may be conducted in the presence of preheated air, typically dry preheated air.

The composition may be milled or ground to form a homogeneous crystal size.

The composition may be mixed with bulking agents and/or other soil conditioning agents to produce a particulate soil treatment composition.

The bulking agents may include lime, bentonite, and the like.

The other soil conditioning agents may include organic matter, such as composted chicken manure, sorghum waste, soya waste, sunflower seed waste, and the like.

The soil conditioning agents may also include bio-humate, such as bacteria, and growth stimulants, particularly where the composition is to be used in poor soils such as sand dunes and the like.

The soil conditioning agents may include macro and/or micro trace elements.

The composition, with or without some or all of the bulking and conditioning agents, may be extruded to form pellets or granules suitable for addition to soil.

To aid the extrusion process binding agents such as natural gums, molasses, dextrose, or the like, may be used.

According to a second aspect of the invention, there is provided a soil improving and fertilising composition including:

fertiliser; and

potassium crosslinked copolymer.

At least some of the fertiliser and the potassium crosslinked copolymer may be mechanically fused.

The fertiliser may be any normal agricultural or horticultural fertiliser including macro nutrients, such as K, P and N, and micro nutrients, such as Zn, Cu, and the like.

Typically the fertiliser is a granulated fertiliser.

The fertiliser may be any plant nutrient composition.

The crosslinked copolymer may be crosslinked polyacrylate/polyacrylamide copolymer.

Typically the crosslinked copolymer is crosslinked potassium polyacrylate/polyacrylamide copolymer, such as that available under the trade name Stockasorb from Stockhausen GmbH in Germany.

Prior to mixing with the fertiliser, the crosslinked copolymer may be in the form of granules having a bulk density of from about 500 to 580 Kg/m³, typically 540 Kg/m³, and a moisture content of about from 3% to 7%, typically 5%.

Prior to mixing with the fertiliser, the crosslinked copolymer granules may have a particle size distribution of from 50 to 5000 microns, typically from 100 to 3000 microns. Usual particle size distributions include from 200 to 800 microns, from 800 to 3000 microns, and from 100 to 800 microns.

The composition may include from 1% to 99.9% by mass of said copolymer, however, typically it will include from about 9% to about 80% by mass of said copolymer.

In one embodiment, the composition includes 40% of said copolymer.

The composition may be milled or ground to form a homogeneous crystal size.

The composition may be mixed with bulking agents and/or other soil conditioning agents to produce a particulate soil treatment composition.

The bulking agents may include lime, bentonite, and the like.

The other soil conditioning agents may include organic matter, such as composted chicken manure, sorghum waste, soya waste, sunflower seed waste, and the like.

The soil conditioning agents may also include bio-humate, such as bacteria, and growth stimulants, particularly where the composition is to be used in poor soils such as sand dunes and the like.

The soil conditioning agents may include macro and/or micro trace elements.

The composition, with or without some or all of the bulking and conditioning agents, may be extruded to form pellets or granules suitable for addition to soil.

To aid the extrusion process binding agents such as natural gums, molasses, dextrose, or the like, may be used.

The composition may be a fertiliser extender so that less fertiliser active ingredients are required to fertilise the soil while also reducing the cost of fertilising the soil.

The composition may be a slow release fertilising composition so that fertilising nutrients are released to the plants over an extended period when compared to the fertiliser component of the composition.

The composition may have an absorption capacity of 300 ml of water per 1.25 g of composition having 80% copolymer and 20% fertiliser. This water is available to a plant's root system.

According to a third aspect of the invention there is provided an agricultural method including the use of a soil improving and fertilising composition substantially as described above, the method including the distribution of said composition in soil so as to increase the yield of any crops planted in that soil.

The composition may be applied to the soil either before planting or after planting.

In the case of application of the composition after planting the composition may be introduced into the soil by pressure injection, by puncturing the soil, or by other suitable non-destructive means which do not destroy the plants already present in the soil. The composition is deposited at root level so that the roots of the plants may draw water and nutrients therefrom.

The composition may be distributed at a rate of from 10 Kg per hectare to get increased crop yields.

In the case of Maize, the composition is distributed at a rate of 25 Kg per hectare thereby to obtain increased maize crop yield while reducing the watering requirement to, or maintaining a low watering requirement of, about 25 mm rain equivalent per month while obtaining maize crop yields equivalent to that obtained with 100 mm rain equivalent over 90 days without the composition.

In the case of golf course grass, 50 g per m² of a composition including 60% copolymer and 40% lawn fertiliser provides improved grass density and vitality.

The composition may be distributed to reduce evaporation losses from the soil.

The composition may be distributed to improve soil aeration. This is achieved when the water which has been absorbed by the composition is used up by the plants thereby leaving an air pocket in the soil.

### DESCRIPTION OF THE DIAGRAMS

The invention will now be described by way of example only with reference to the accompanying diagrams.

In the diagrams,

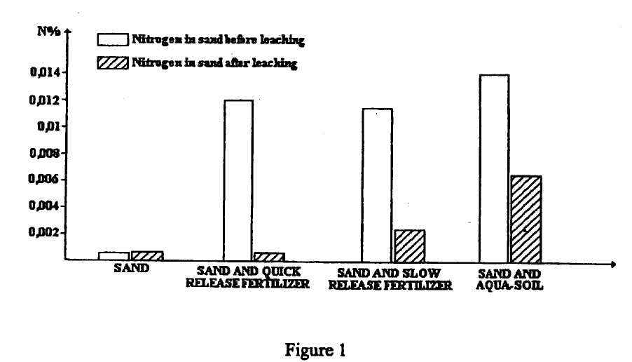

FIG. 1 shows a graph of a nitrogen retention test on a composition of the invention;

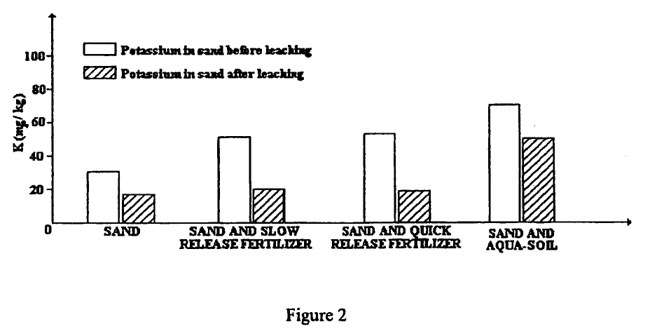

FIG. 2 shows a graph of a potassium retention test on a composition of the invention;

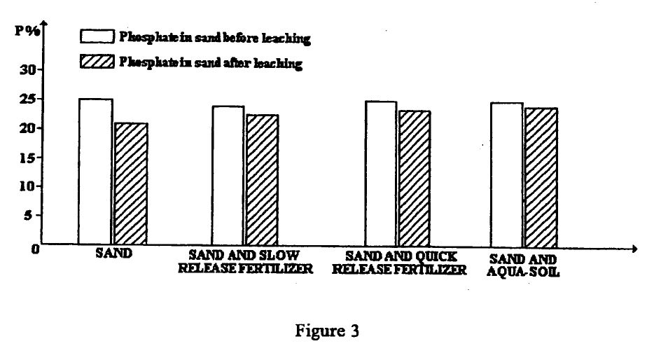

FIG. 3 shows a graph of a phosphate retention test on a composition of the invention; and

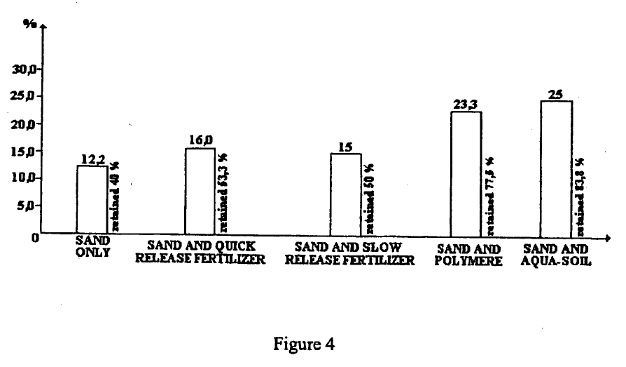

FIG. 4 shows a graph of a water retention test on a composition of the invention;

The composition of the invention is an environmentally friendly, spongeous water and fertiliser reservoir in the soil, providing water and nutrients directly to the plant roots through normal capillary action and active absorption osmosis.

One example of such composition suitable for trees is shown in Table 1 below.

| Component | Mass % |
|---|---|
| Potassium Nitrate | 19.70 |
| MAP | 16.00 |
| Urea | 9.30 |
| Potassium Sulphate | 2.80 |
| Magnesium Sulphate | 1.383 |
| Zn EDTA | 0.170 |
| Fe EDTA | 0.195 |
| Mn EDTA | 0.080 |
| Cu EDTA | 0.075 |
| Boric Acid | 0.290 |
| Sodium Molybdate | 0.007 |
| Stockasorb* | 5.00 |
| Betonite | 40.00 |
| Dextrose | 5.00 |
| TOTAL | 100 |

Another example of such composition suitable for gardens is shown in Table 2 below.

| Component | Mass % |
|---|---|
| Potassium Nitrate | 39.60 |
| MAP | 10.32 |
| Urea | 4.44 |
| Potassium Sulphate | 3.36 |
| Magnesium Sulphate | 1.299 |
| Zn EDTA | 0.204 |
| Fe EDTA | 0.234 |
| Mn EDTA | 0.096 |
| Cu EDTA | 0.090 |
| Boric Acid | 0.348 |
| Sodium Molybdate | 0.0085 |
| Stockasorb* | 40.00 |
| TOTAL | 100 |

The water is absorbed by the long chain, cross linked molecular structure thereby preventing rapid drainage of the soil while the added nutrients, in the form of inorganic Potassium, Phosphorous and Nitrogen (KNP) are loosely bound by the anionic negative molecular charge, preventing rapid leaching that may occur in sandy soils.

In FIG. 1, a graph showing the results of a retention test in which soil treated with the composition is exposed to conditions equivalent to 2000 mm of rain in 14 days.

From the results shown in FIG. 1 it is clear that the soil treatment composition retained nitrogen far better than quick or slow release fertiliser thus increasing the nitrogen holding capacity of the soil which is known to stimulate plant productivity.

In FIG. 2, a graph showing the results of a potassium retention test in which soil treated with the composition is exposed to conditions equivalent to 2000 mm of rain in 14 days.

From the results shown in FIG. 2 it is clear that the soil treatment composition retained potassium far better than quick or slow release fertiliser thus increasing the potassium holding capacity of the soil which is known to promote flowering and fruiting.

In FIG. 3, a graph showing the results of a phosphate retention test in which soil treated with the composition is exposed to conditions equivalent to 2000 mm of rain in 14 days.

From the results shown in FIG. 3 it is clear that the soil treatment composition retained phosphate somewhat better than quick or slow release fertiliser thus increasing the phosphate holding capacity of the soil which is known to be required for plant growth.

In FIG. 4, a graph showing the results of a water retention test in which the soil treatment composition is compared to a crosslinked polymer not including fertiliser.

From the results shown in FIG. 4 it is clear that the soil treatment composition retained water far better than the crosslinked copolymer alone i.e. 83.3% v 77.6% thus increasing the water holding capacity of the soil.

Thus a continuous source of water buffering the desiccation effects of hot dry climates is achieved. This allows nutrient take up to continue longer than without the composition thus extending the wilting point by over 100% from 13 days to 29 days after the last irrigation for a fruit tree.

By attaching to soil particles the complex chain molecular structure of the composition strengthens soil aggregates, improves soil structure and maintains micro pores. Thereby limiting erosion potential and reducing soil crust formation caused by irrigation water high in sodium salts.

Tailor made nutrients may form the fertiliser component of the composition to provide for different soil types and for the varied nutritional demands of different plant types, e.g. lawns, vegetables, ornamental flowers and fruit trees.

The composition is non-toxic which biodegrades within 5 years into carbon dioxide, water, potassium and nitrogen.

The composition is used in a method of planting a seedling in a soil and composition mixture thereby to promote root mass and over all plant vitality by providing ready access to water and nutrients while requiring less water.

The seedling is planted in a soil and composition mixture with 200 ml of water instead of the usual 5 to 8 litres.

After the tree seedling has been planted canopy closure can be expected within 12 months rather than the usual 18 to 24 months without the use of the composition.

The inventor believes that advantages of the invention as illustrated include:

drought protection

non-toxic

neutral pH

reduces salination

reduces leaching

reduces water costs

reduces fertiliser costs

reduces plant mortality by up to 90%

water saving of 50%

improves root aeration

limits soil erosion

improves seed germination.

1. A process for preparing a soil improving and fertilising composition from fertiliser and crosslinked copolymer, the process including imparting an electrical charge to at least one of said copolymer and the fertiliser and bringing said copolymer and fertiliser into intimate contact with each other, and wherein the bulk density of the composition increases by at least 2% over that of the fertiliser and crosslinked copolymer simply mixed.

2. A process as claimed in claim 1, wherein the copolymer is in the form of granules.

3. A process as claimed in claim 1 or claim 2, wherein the electrical charge is imparted by high shear mixing of the fertiliser and said copolymer.

4. A process as claimed in claim 3, wherein the high shear mixing is carried out in a high speed mixing vessel.

5. A process as claimed in any one of the preceding claims, wherein the electrical charge is imparted by negative charging with a corona discharge device.

6. A process as claimed in any one of claims 3 to 5, wherein the high shear mixing is carried out at a temperature of from ambient temperature to 90° C.

7. A process as claimed in any one of the preceding claims, wherein the crosslinked copolymer is a crosslinked potassium copolymer.

8. A process as claimed in claims 7, wherein the crosslinked copolymer is a polyacrylate/polyacrylamide potassium crosslinked copolymer.

9. A process as claimed in claim 1, wherein the bulk density increases by at least 5%.

10. A process as claimed in any one of claims 3 to 9, wherein the high shear mixing is conducted under substantially dry conditions without the addition of additional moisture to the composition.

11. A process as claimed in claim 10, wherein the high shear mixing is conducted in the presence of preheated air.

12. A process as claimed in any one the preceding claims, wherein the composition is milled or ground to form a homogeneous crystal size.

13. A process as claimed in any one of the preceding claims, wherein the composition is mixed with bulking agents and/or other soil conditioning agents to produce a particulate soil treatment composition.

14. A process as claimed in claim 13, wherein the bulking agents include lime, bentonite, and the like.

15. A process as claimed in claim 13 or claim 14, wherein the soil conditioning agents include organic matter, such as composted chicken manure, sorghum waste, soya waste, sunflower seed waste, and the like.

16. A process as claimed in any of claims 13 to 15, wherein the soil conditioning agents include bio-humate, such as bacteria, and growth stimulants, particularly where the composition is to be used in poor soils such as sand dunes and the like.

17. A process as claimed in any one of claims 13 to 16, wherein the soil conditioning agents include macro and/or micro trace elements.

18. A process as claimed in any one of the preceding claims, wherein the composition is extruded to form pellets or granules suitable for addition to soil.

19. A process as claimed in claim 18, wherein to aid the extrusion process binding agents such as natural gums, molasses, dextrose, or the like, are used.

20. A soil improving and fertilising composition including:
fertiliser;
potassium crosslinked copolymer, and
wherein at least some of the fertiliser and the potassium crosslinked copolymer are mechanically fused.

21. A composition as claimed in claim 20, wherein the fertiliser is any normal agricultural or horticultural fertiliser including macro nutrients, such as K, P and N, and micro nutrients, such as Zn, Cu, and the like.

22. A composition as claimed in claim 20 or 21, wherein the fertiliser is a granulated fertiliser.

23. A composition as claimed in any one of claims 20 to 22, wherein the potassium crosslinked copolymer is a crosslinked polyacrylate/polyacrylamide copolymer.

24. A composition as claimed in any one of claims 20 to 23, wherein prior to mixing with the fertiliser, the crosslinked copolymer is in the form of granules having a bulk density of from about 500 to 580 Kg/m³ and a moisture content of about from 3% to 7%.

25. A composition as claimed in any one of claims 20 to 23, wherein prior to mixing with the fertiliser, the crosslinked copolymer is in the form of granules having a bulk density of about 540 Kg/m³ and a moisture content of about 5% to 7%.

26. A composition as claimed in any one of claims 20 to 25, wherein prior to mixing with the fertiliser, the crosslinked copolymer granules have a particle size distribution of from 50 to 5000 microns.

27. A composition as claimed in any one of claims 20 to 25, wherein prior to mixing with the fertiliser, the crosslinked copolymer granules have a particle size distribution of from 100 to 3000 microns.

28. A composition as claimed in any one of claims 20 to 25, wherein prior to mixing with the fertiliser, the crosslinked copolymer granules have a particle size distribution of from 200 to 800 microns.

29. A composition as claimed in any one of claims 20 to 25, wherein prior to mixing with the fertiliser, the crosslinked copolymer granules have a particle size distribution of from 800 to 3000 microns.

30. A composition as claimed in any one of claims 20 to 29, including from 1% to 99.9% by mass of said copolymer.

31. A composition as claimed in any of claims 20 to 29, including from about 9% to about 80% by mass of said copolymer.

32. A composition as claimed in any one of claims 20 to 31, including 40% of said copolymer.

33. A composition as claimed in any one of claims 20 to 32, having an absorption capacity of 300 ml of water per 1.25 g of composition having 80% copolymer and 20% fertiliser.

34. An agricultural or horticultural method including the use of a soil improving and fertilising composition as claimed in any one of claims 20 to 33 or as made by a process as claimed in any one of claims 1 to 19, the method including the distribution of said composition in soil so as to increase the yield of any plants planted in that soil.

35. A method as claimed in claim 34, wherein the composition is applied to the soil either before planting or after planting.

36. A method as claimed in claim 35, wherein in the case of application of the composition after planting the composition is introduced into the soil by pressure injection, by puncturing the soil, or by other suitable non-destructive means which do not destroy the plants already present in the soil and whereby the composition is deposited at root level so that the roots of the plants can draw water and nutrients therefrom.

37. A method as claimed in any one of claims 34 to 36, wherein the composition is distributed at a rate of from 10 Kg per hectare.

38. A method as claimed in any one of claims 34 to 37, wherein in the case of Maize, the composition is distributed at a rate of 25 Kg per hectare thereby to obtain increased maize crop yield while reducing the watering requirement to, or maintaining a low watering requirement of, about 25 mm rain equivalent per month.

39. A method as claimed in any one of claims 34 to 37, wherein in the case of golf course grass, 50 g per m² of a composition including 60% copolymer and 40% lawn fertiliser provides improved grass density and vitality.
